(19) United States
(12) Patent Application Publication
(10) Pub. No.: US 2025/0197977 A1
(43) Pub. Date: Jun. 19, 2025

(54) R-T-B SINTERED MAGNET

(71) Applicant: PROTERIAL, LTD., Tokyo (JP)

(72) Inventor: Futoshi KUNIYOSHI, Tokyo (JP)

(21) Appl. No.: 18/845,995

(22) PCT Filed: Feb. 22, 2023
(86) PCT No.: PCT/JP2023/006575

§ 371 Date: Sep. 11, 2024

(30) Foreign Application Priority Data
Mar. 22, 2022 (JP) 2022-045078

(51) Int. Cl. C22C 38/00; B22F 3/16; B22F 3/24; B22F 9/00; B22F 9/02; B22F 9/04; C22C 28/00; C22C 38/06; C22C 38/10; C22C 38/14; C22C 38/16; C23C 10/30; H01F 1/057; H01F 41/02

(52) U.S. Cl. CPC C22C 38/005; B22F 3/16; B22F 3/24; B22F 9/008; B22F 9/023; B22F 9/04; C22C 28/00; C22C 38/002; C22C 38/06; C22C 38/10; C22C 38/14; C22C 38/16; C23C 10/30; H01F 1/0577; B22F 2003/242; B22F 2003/248; B22F 2009/044; B22F 2201/02; B22F 2201/11; B22F 2201/20; B22F 2202/05; B22F 2301/355; B22F 2998/10; B22F 2999/00; C22C 2202/02; H01F 41/0293

(57) ABSTRACT

An R-T-B sintered magnet of the present disclosure includes a principal phase that comprises an R₂T₁₄B compound and a grain boundary phase located in a grain boundary portion of the principal phase. The atomic ratio of B to T in the R-T-B sintered magnet is lower than the atomic ratio of B to T in the chemical stoichiometric composition of the R₂T₁₄B compound. The relationships 26.0 mass %≤[Nd]+[Pr]+[Ce]+[La]+[Dy]+[Tb])−12 ([O]+[C])≤27.7 mass %, 0.85 mass %≤[B]≤0.94, 0.05 mass %≤[O]≤[0.30] mass %, 0.05 mass %≤[M]≤2.00 mass %, [Tb]≤0.20 mass %, and [Dy]≤0.30 mass % are satisfied. A section is included in which at least the Nd concentration or the Pr concentration gradually decreases gradually from the front surface of the magnet toward the interior of the magnet.

### TECHNICAL FIELD

The present invention relates to a sintered R-T-B based magnet.

### BACKGROUND ART

Sintered R-T-B based magnets (where R is at least one of rare-earth elements; T is Fe, or Fe and Co; and B is boron) are known as permanent magnets with the highest performance. Therefore, the sintered R-T-B based magnets are used in various types of motors in the field of vehicles such as electric vehicles (EV, HV, PHV) and the like, in the field of renewable energy such as wind power generation and the like, in the field of consumer electronics, in the field of industrial equipment, and the like. The sintered R-T-B based magnets are indispensable to decrease the size and the weight of, to increase the efficiency of, and to realize energy savings for (to improve the energy efficiency of) these motors. The sintered R-T-B based magnets are also used in driving motors of electric vehicles. In the current state where vehicles using internal combustion engine are being replaced with electric vehicles, the sintered R-T-B based magnets contribute to decrease greenhouse gas such as carbon dioxide or the like (to decrease fuel gas and exhaust gas) and thus to prevent global warming. As can be seen, the sintered R-T-B based magnets significantly contribute to the realization of a clean energy society.

A sintered R-T-B based magnet includes a main phase which is mainly formed of an R₂T₁₄B compound and a grain boundary phase that is at the grain boundaries of the main phase. The R₂T₁₄B compound, which forms the main phase, is a ferromagnetic material having high saturation magnetization and an anisotropy field, and has a strong influence on the properties of the sintered R-T-B based magnet.

There exists a problem in that coercivity H_{cJ}(hereinafter, simply referred to as “H_{cJ}”) of sintered R-T-B based magnets decreases at high temperatures, thus causing an irreversible thermal demagnetization. For this reason, sintered R-T-B based magnets for use in motors for electric vehicles, in particular, are required to have high H_{cJ} even at high temperatures, i.e., to have higher H_{cJ} at room temperature.

### CITATION LIST

### Patent Literature

Patent Document No. 1: International Publication No. 2007/102391
Patent Document No. 2: International Publication No. 2018/143230

### SUMMARY OF INVENTION

### Technical Problem

It is known that in the case where a light rare-earth element RL (mainly, Nd or Pr) in an R₂T₁₄B-based compound is replaced with a heavy rare-earth element RH (mainly, Tb or Dy), the H_{cJ} is improved. However, there is a problem that such a replacement, although improving the H_{cJ}, decreases the saturation magnetization of the R₂T₁₄B-based compound phase and therefore, decreases remanence Bᵣ (hereinafter, simply referred to as “Bᵣ”). Tb, particularly, is present in a very small quantity as resources and is produced in limited areas. For this and other reasons, Tb has problems of not being supplied stably and changing in costs. Therefore, it is demanded to provide high H_{cJ} while suppressing the decrease in the Bᵣ with Tb being used as little as possible (with Tb being used in a minimum possible amount).

Patent Document No. 1 describes supplying a heavy rare-earth element RH to a surface of a sintered magnet of an R-T-B based alloy while diffusing the heavy rare-earth element RH into an interior of the sintered magnet. According to the method described in Patent Document No. 1, the heavy rare-earth element RH is diffused from a surface of the sintered R-T-B based magnet into the interior thereof to concentrate the heavy rare-earth element RH in outer shells of main phase crystal grains, which is effective to improve the H_{cJ}. In this manner, high H_{cJ} is provided while the decrease in the Bᵣ is suppressed.

Patent Document No. 2 describes diffusing a light rare-earth element RL and Ga, in addition to a heavy rare-earth element RH, from a surface of a sintered R-T-B based body into an interior of the magnet via grain boundaries. According to the method described in Patent Document No. 2, the diffusion of the heavy rare-earth element RH into the interior of the magnet is promoted, so that very high H_{cJ} is provided while the amount of use of the heavy rare-earth element RH is decreased.

It has been recently demanded to, particularly for the motors for electric vehicles and the like, provide higher Bᵣ and higher H_{cJ} with the amount of use of a heavy rare-earth element RH, particularly Tb or the like, being decreased.

Various embodiments of the present disclosure provide a sintered R-T-B based magnet having high Bᵣ and high H_{cJ} with the amount of use of a heavy rare-earth element RH such as Tb or the like being decreased.

### Solution to Problem

In a non-limiting illustrative embodiment, a sintered R-T-B based magnet (where R is at least one of rare-earth elements and contains with no exception, T is Fe or Fe and Co, and B is boron) according to the present disclosure includes a main phase formed of an R₂T₁₄B compound; and a grain boundary phase that is at grain boundaries of the main phase. Where Nd is contained at a content (mass %) represented as [Nd], Pr is contained at a content (mass %) represented as [Pr], Ce is contained at a content (mass %) represented as [Ce], La is contained at a content (mass %) represented as [La], Dy is contained at a content (mass %) represented as [Dy], Tb is contained at a content (mass %) represented as [Tb], B is contained at a content (mass %) represented as [B], O is contained at a content (mass %) represented as [O], C is contained at a content (mass %) represented as [C], and M (M is at least one selected from the group consisting of Ga, Cu, Zn, Al and Si) is contained at a content (mass %) represented as [M], an atomic ratio of B with respect to T in the sintered R-T-B based magnet is lower than an atomic ratio of B with respect to T in a stoichiometric composition of the R₂T₁₄B compound. The sintered R-T-B based magnet satisfies the relationships of 26.0 mass %≤([Nd]+[Pr]+[Ce]+[La]+[Dy]+[Tb])−12([O]+[C])≤27.7 mass %, 0.85 mass %≤[B]≤0.94 mass %, 0.05 mass %≤[O]≤0.30 mass %, 0.05 mass %≤[M]≤2.00 mass %, [Tb]≤0.20 mass %, and [Dy]≤0.30 mass %. The sintered R-T-B based magnet includes a portion in which at least one of a concentration of Nd and a concentration of Pr gradually decreases from a surface toward an interior thereof.

In an embodiment, the sintered R-T-B based magnet includes a portion in which a concentration of M gradually decreases from the surface toward the interior thereof.

In an embodiment, the sintered R-T-B based magnet includes a portion in which a concentration of Pr gradually decreases from the surface toward the interior thereof.

In an embodiment, 0.85 mass %≤[B]≤0.92 mass %.

In an embodiment, 0.05 mass %≤[Tb]≤0.20 mass %, and the sintered R-T-B based magnet has remanence Bᵣ not lower than 1.43 T and coercivity H_{cJ} not lower than 1900 kA/m.

In an embodiment, the sintered R-T-B based magnet does not contain Tb (except for unavoidable impurities) and has remanence Bᵣ not lower than 1.40 T and coercivity H_{cJ} not lower than 1400 kA/m, and where Bᵣ has a value (T) of [Y] and H_{cJ} has a value (kA/m) of [X], the sintered R-T-B based magnet satisfies the relationship of [Y]≥−0.0002×[X]+1.73.

In an embodiment, the sintered R-T-B based magnet further includes Ga and Cu. Where Ga is contained at a content (mass %) represented as [Ga] and Cu is contained at a content (mass %) represented as [Cu], [Ga]≥1.2×[Cu].

### Advantageous Effects of Invention

Embodiments of the present disclosure provide a sintered R-T-B based magnet having high Bᵣ and high H_{cJ} with the amount of use of a heavy rare-earth element RH such as Tb or the like being decreased.

### BRIEF DESCRIPTION OF DRAWINGS

FIG. 1A is an enlarged schematic cross-sectional view of a part of a sintered R-T-B based magnet.

FIG. 1B is a further enlarged schematic cross-sectional view of the broken-lined rectangular region in FIG. 1A.

FIG. 2A is a perspective view schematically showing a sintered R-T-B based magnet 100 according to an embodiment of the present disclosure.

FIG. 2B is a graph showing an example of a portion, of the sintered R-T-B based magnet 100, in which at least one of a concentration of Nd and a concentration of Pr gradually decreases from a surface toward an interior thereof.

FIG. 3 is a flowchart showing example steps of a method for producing the sintered R-T-B based magnet according to an embodiment of the present disclosure.

### DESCRIPTION OF EMBODIMENTS

First, a fundamental structure of a sintered R-T-B based magnet according to the present disclosure will be described. The sintered R-T-B based magnet has a structure in which powder particles of a raw material alloy are bound together through sintering, and includes a main phase which is mainly formed of R₂T₁₄B compound grains and a grain boundary phase which is at the grain boundaries of the main phase.

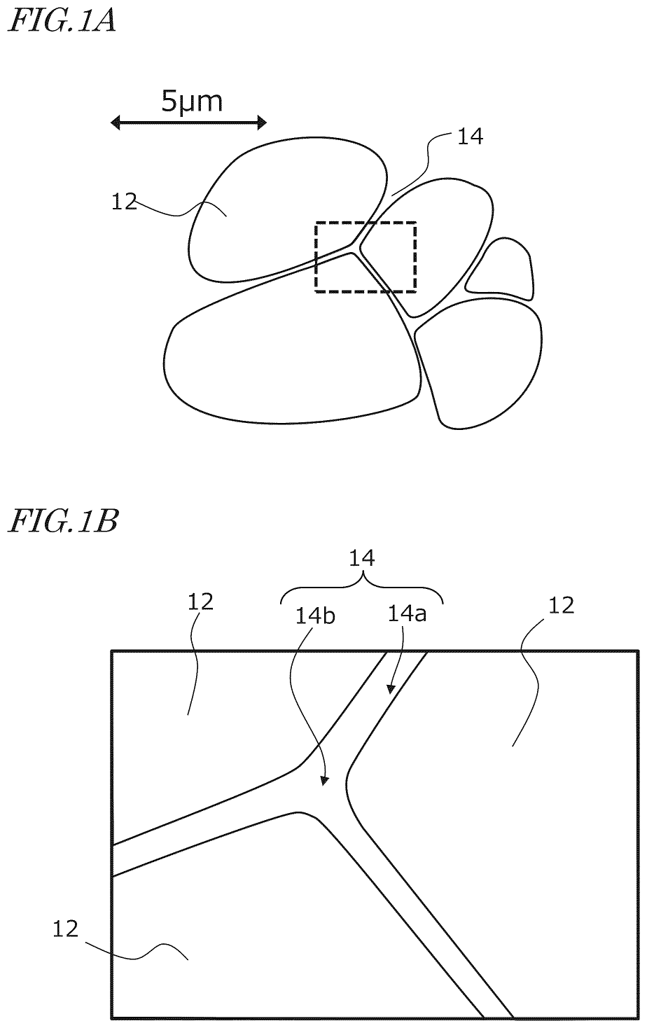

FIG. 1A is an enlarged schematic cross-sectional view of a part of a sintered R-T-B based magnet. FIG. 1B is a further enlarged schematic cross-sectional view of the broken-lined rectangular region in FIG. 1A. In FIG. 1A, an arrow indicating a length of 5 μm is shown as an example of reference length to represent sizes. As shown in FIG. 1A and FIG. 1B, the sintered R-T-B based magnet includes a main phase 12 mainly formed of an R₂T₁₄B compound and a grain boundary phase 14 at the grain boundaries of the main phase 12. As shown in FIG. 1B, the grain boundary phase 14 includes an intergranular grain boundary phase 14a, along which two R₂T₁₄B compound grains adjoin each other, and a grain boundary triple junction 14b, at which three R₂T₁₄B compound grains adjoin one another. A typical crystal grain size of the main phase is not shorter than 3 μm and not longer than 10 μm, this being an average value of the diameter of an approximating circle in a cross section of the magnet. The R₂T₁₄B compound, which forms the main phase 12, is a ferromagnetic material having high saturation magnetization and an anisotropy field. Therefore, in a sintered R-T-B based magnet, it is possible to improve the Bᵣ by increasing the abundance ratio of the R₂T₁₄B compound, which forms the main phase 12. In order to increase the abundance ratio of the R₂T₁₄B compound, an amount of R, an amount of T and an amount of B in the raw material alloy may be brought closer to the stoichiometric ratio of the R₂T₁₄B compound (i.e., the R amount:the T amount:the B amount=2:14:1).

However, because the sintered R-T-B based magnet also includes the grain boundary phase 14, R, T and B in the raw material alloy are consumed to form the grain boundary phase 14 as well as to form the main phase 12. The grain boundary phase 14 is melted during a sintering step and acts to physically bind the R₂T₁₄B compound grains, which form the main phase 12, to each other. Therefore, the grain boundary phase 14 is conventionally designed to have a rare-earth-rich (R-rich) composition having a relatively low melting point. Specifically, the composition of the raw material alloy is conventionally set to be larger than the stoichiometric ratio of the R₂T₁₄B compound, so that the resultant extra R is used to form the grain boundary phase. It is also known that the structure of the grain boundary phase 14, specifically, the types and the amounts of the substances contained in the grain boundary phase 14 affects the level of the H_{cJ}.

As described above, according to the method described in Patent Document No. 2, R and Ga are diffused from a surface of a sintered R-T-B based body into an interior of the magnet via grain boundaries. R and Ga diffused in the grain boundaries are diffused into the interior of the magnet, and as a result, high H_{cJ} is realized. However, as a result of studies made by the present inventor, it has been found out that in the case where R and Ga are diffused into the interior of the magnet, the intergranular grain boundary phase may possibly become excessively thick and thus the volume ratio of the main phase may be decreased, resulting in a decrease in the Bᵣ. It has been found out that for this reason, the amounts of R and Ga to be diffused need to be minimum necessary amounts in order to prevent the intergranular grain boundary phase from becoming excessively thick.

It has also been found out that the structure of the grain boundary phase (the types and the concentrations of substances that may exist in the grain boundaries, such as iron-based compounds, rare-earth compounds and the like) is changed in accordance with whether an atomic ratio of B with respect to T, that is, B/T, in the sintered R-T-B based magnet is higher or lower than an atomic ratio of B with respect to T in the stoichiometric composition of the R₂T₁₄B compound.

The present inventor has found out that in the case where the atomic ratio of B with respect to T, that is, B/T, in the sintered R-T-B based magnet is lower than 1/14, which is the atonic ratio of B with respect to T in the stoichiometric composition of the R₂T₁₄B compound, the effect, provided by the diffusion of R and Ga in the grain boundaries, of improving the properties of the magnet is enhanced. More specifically, in the case where the atomic ratio of B/T is lower than 1/14, the diffusion of R and Ga in the grain boundaries is promoted. Even in the case where B is partially replaced with carbon (C) in the R₂T₁₄B compound, substantially the same effect is provided. It has also been found out that even in the case where at least one selected from the group consisting of Cu, Zn, Al and Si is diffused instead of, or in addition to, Ga, the properties of the magnet are improved. Hereinafter, at least one metal material selected from the group consisting of Ga, Cu, Zn, Al and Si will collectively be referred to as a “metal element M”.

As can be seen, in the case where R or the metal element M is diffused from the surface of the sintered R-T-B based body into the interior thereof, the atomic ratio of B/T is one of important parameters for adjusting the behavior of the diffusion in the grain to improve the properties of the magnet. Hereinafter, a sintered R-T-B based body in which the atomic ratio of B/T is lower than 1/14, and a sintered R-T-B based magnet in which the atomic ratio of B/T is lower than 1/14, may respectively be referred to as a “low-boron sintered R-T-B based body” and a “low-boron sintered R-T-B based magnet”. In the present disclosure, a sintered R-T-B based magnet before and during the diffusion will be referred to as a “sintered R-T-B based body”, and a sintered R-T-B based magnet after the diffusion will be referred to simply as a “sintered R-T-B based magnet”.

As a result of further studies of the present inventor, it has been found out that C, replacing B in the R₂T₁₄B compound forming the main phase, is bound with a rare-earth oxide in the grain boundaries during the sintering step and generates a rare-earth oxygen carbon compound (R-O-C compound) in the grain boundaries. It has also been found out that the atomic ratio in this case is R:(C, O)=1:1. In the case where such an R-O-C compound is generated in the grain boundaries, the content of C in the R₂T₁₄B compound as the main phase is decreased accordingly. As described above, even in the case where B in the R₂T₁₄B compound is partially replaced with C, the effect by the “low boron” is provided. Therefore, the decrease in the content of C in the R₂T₁₄B compound as the main phase indicates that the total amount of B and C is effectively decreased. The formation of the R-O-C compound in the grain boundaries indicates that the rare-earth element R contained in the raw material alloy is partially consumed to generate the R-O-C compound. The R-O-C compound contains an R-O compound (rare-earth oxide) and an R-C compound (rare-earth carbide).

Based on the above, the present inventor conceived as follows: in the case where R or a metal element M is diffused from a surface of a low-boron sintered R-T-B based body into an interior thereof, the thickness or the structure of the grain boundaries needs to be controlled in order to optimize the effect, provided by the diffusion, of improving the properties of the magnet; and for this purpose, the contents of R, O and C need to satisfy an appropriate relationship. The present inventor also conceived as follows: in the case where R having an appropriate relationship with the contents of O and C contains boron at a content in a specific low range, the effect, provided by the diffusion of R and M in the grain boundaries, of improving the properties of the magnet is enhanced. As a result of studies, the present inventor has found out the following: where Nd is contained at a content (mass %) represented as [Nd], Pr is contained at a content (mass %) represented as [Pr], Ce is contained at a content (mass %) represented as [Ce], La is contained at a content (mass %) represented as [La], Dy is contained at a content (mass %) represented as [Dy], Tb is contained at a content (mass %) represented as [Tb], B is contained at a content (mass %) represented as [B], O is contained at a content (mass %) represented as [O], and C is contained at a content (mass %) represented as [C], in the case where R or a metal element M is diffused to a sintered R-T-B based body adjusted to contain the substances in the ranges of 0.85 mass %≤[B]≤0.94 mass % and 25.8 mass %≤≤([Nd]+[Pr]+[Ce]+[La]+[Dy]+[Tb])−12([O]+[C])≤27.5 mass %, neither R nor M is excessively diffused into the interior of the magnet and appropriate intergranular grain boundaries are formed. The atomic ratio of B with respect to T in the resultant sintered R-T-B based magnet is lower than the atomic ratio of B with respect to T in the stoichiometric composition of the R₂T₁₄B compound. The resultant sintered R-T-B based magnet satisfies the relationships of:

$$26. mass \% \leq ( [ Nd ] + [ Pr ] + [ Ce ] + [ La ] + [ Dy ] + [ Tb ] ) - 12 ( [ O ] + [ C ] ) \leq 27.7 mass \% ;$$

$$0.85 mass \% \leq [ B ] \leq 0.94 mass \% ;$$

$$0.05 mass \% \leq [ O ] \leq 0.3 mass \% ;$$

$$0.05 mass \% \leq [ M ] \leq 2. mass \% ;$$

$$[ Tb ] \leq 0.2 mass \% ; and$$

$$[ Dy ] \leq 0.3 mass \% .$$

Hereinafter, a sintered R-T-B based magnet according to an embodiment of the present disclosure will be described in detail.

### <Sintered R-T-B Based Magnet>

The sintered R-T-B based magnet according to the present disclosure includes a main phase formed of an R₂T₁₄B compound and a grain boundary phase that is at the grain boundaries of the main phase. The sintered R-T-B based magnet includes a portion in which at least one of a concentration of Nd and a concentration of Pr gradually decreases from the surface toward the interior of the magnet. The portion in which at least one of the Nd concentration and the Pr concentration gradually decreases from the surface toward the interior of the magnet is formed by at least one of Nd and Pr being diffused from the surface into the interior of the magnet. This will be described in detail below.

Regarding the sintered R-T-B based magnet according to this embodiment, the content (mass %) of Nd is represented as [Nd], the content (mass %) of Pr is represented as [Pr], the content (mass %) of Ce is represented as [Ce], the content (mass %) of La is represented as [La], the content (mass %) of Dy is represented as [Dy], the content (mass %) of Tb is represented as [Tb], the content (mass %) of T is represented as [T], the content (mass %) of B is represented as [B], the content (mass %) of O is represented as [O], the content (mass %) of C is represented as [C], and the content (mass %) of the metal element M is represented as [M]. In the case where there is no specific limitation on the lower limit of each of these contents, these contents may each be 0 mass %, or a value not higher than the measurement limit. In other words, the sintered R-T-B based magnet according to this embodiment does not need to contain, for example, Ce, La, Tb or Dy.

As described above, in this embodiment, the atomic ratio with respect to T in the sintered R-T-B based magnet is lower than the atomic ratio of B with respect to T in the stoichiometric composition of the R₂T₁₄B compound. This is represented by expression (1) below by use of the mass ratio (mass %), instead of the atomic ratio (the atomic weight of Fe is used because T is based on Fe).

$$[ T ] / 55.85 > 14 \times [ B ] / 10.8 \qquad ( 1 )$$

In the sintered R-T-B based magnet according to this embodiment, oxygen is contained at a content in a range defined by 0.05 mass %≤[O]≤0.30 mass %. Such an amount of oxygen may be realized by controlling oxidation conditions for production of coarse-pulverized powder (hydrogen-pulverized powder) or fine-pulverized powder of the raw material alloy. This will be described in detail below.

The sintered R-T-B based magnet according to this embodiment satisfies expression (2) below.

$$26. mass \% \leq ( [ Nd ] + [ Pr ] + [ Ce ] + [ La ] + [ Dy ] + [ Tb ] ) - 12 ( [ O ] + [ C ] ) \leq 27.7 mass \% \qquad ( 2 )$$

That is, in this embodiment, the contents of R (R is at least one of rare-earth elements, and contains Nd with no exception), O and C in the sintered R-T-B based body are adjusted, and thus expression (2) is satisfied. The content of C may be adjusted by the amount of a lubricant incorporated at the time of pulverization or pressing. A range preferred to expression (2) is not lower than 26.0 mass % and not higher than 27.5 mass %. With such a range, high Bᵣ and high H_{cJ} are provided while the amount of use of a heavy rare-earth element RH such as Tb or the like is further decreased.

Expression (2) above represents an effective range of the contents of the rare-earth elements excluding elements, among the elements of R in the sintered R-T-B based magnet, that are incorporated into the grain boundary phase as a result of being bound with O or C. Nd is a main component of the rare-earth elements contained in the sintered R-T-B based magnet. Therefore, Nd may be selected as a representative of Nd, Pr, Ce, La, Dy and Tb, and C, which may replace B in the R₂T₁₄B compound as the main phase, may be selected as a representative of O and C, so that the weight ratio of the rare-earth elements to be consumed is estimated. Nd has an atomic weight of about 144, and C has an atomic weight of 12. Therefore, [Nd] of 144/12=12.0 mass % is consumed as a result of Nd being bound with 1.0 mass % of [C]. As can be seen from this, expression (2) proximately indicates the amounts of the rare-earth elements remaining after rare-earth elements that are to be consumed to be bound with C or O are excluded from the rare-earth elements (Nd, Pr, Ce, Dy, Tb).

In the present disclosure, ([Nd]+[Pr]+[Ce]+[La]+[Dy]+[Tb])−12×([O]+[C]) may be referred to as an “R′ amount”. Expression (2) above indicates that the R′ amount is in the range that is not lower than 26.0 mass % and not higher than 27.7 mass %. It has been found out that in the case where the R′ amount is lower than 26.0 mass %, there is a possibility that neither R nor M is easily supplied into the interior of the magnet from the surface thereof and the H_{cJ} is decreased. It has also been found out that in the case where the R′ amount is higher than 27.7 mass %, there is a possibility that R and the like are excessively diffused into the interior of the magnet from the surface thereof and the Bᵣ is decreased. In the case where the R′ amount is in the range of expression (2), higher Bᵣ and higher H_{cJ} are provided.

In the sintered R-T-B based magnet according to this embodiment, the content of Tb is [Tb]≤0.20 mass %, and the content of Dy is [Dy]≤0.30 mass %. The content of oxygen is adjusted to be in the above-mentioned range, and then R is controlled so as to satisfy expression (2). As a result, intended superb magnetic properties are provided even with relatively low contents of Tb and Dy, without a metal element M such as Ga or the like or R being excessively diffused into the interior of the magnet.

In the sintered R-T-B based magnet according to this embodiment, at least one of Nd and Pr is diffused from the surface into the interior thereof. As a result, the sintered R-T-B based magnet includes a portion in which at least one of the Nd concentration and the Pr concentration gradually decreases from the surface toward the interior of the magnet.

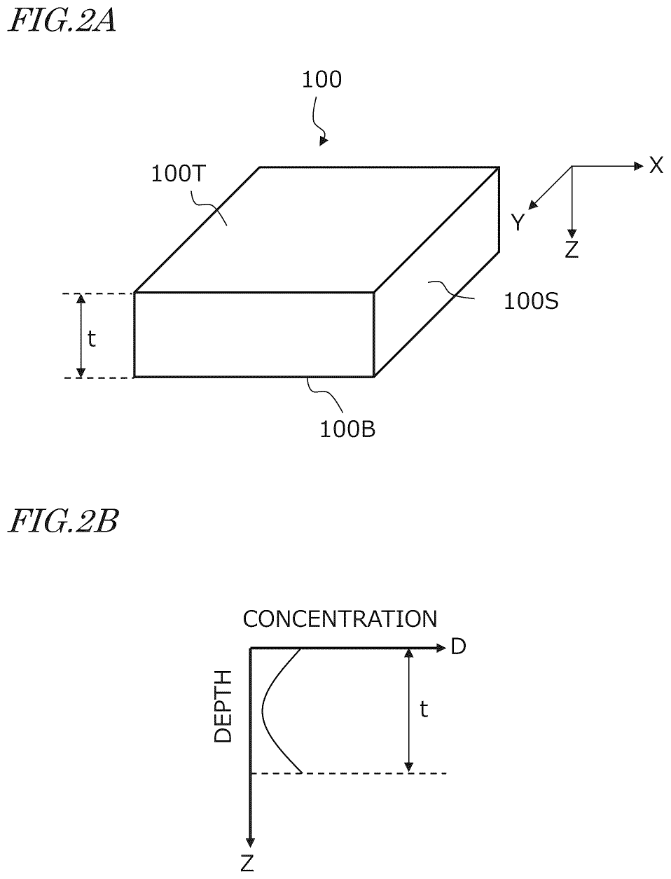

FIG. 2A is a perspective view schematically showing a sintered R-T-B based magnet 100 according to this embodiment. FIG. 2B is a graph showing an example of a portion of the sintered R-T-B based magnet 100 in which at least one of the concentration of Nb and the concentration of Pr gradually decreases from the surface toward the interior thereof. FIG. 2A shows an X axis, a Y axis and a Z axis perpendicular to each other for reference.

In the example shown in FIG. 2A, the sintered R-T-B based magnet 100 has a top surface 100T, a bottom surface 100B and side surfaces 100S, which each correspond to a part of the surface of the magnet. The size in the Z-axis direction of the sintered R-T-B based magnet 100 is thickness t. In the graph shown in FIG. 2B, the vertical axis represents the depth (Z) from the top surface 100T of the sintered R-T-B based magnet 100, and the horizontal axis represents the concentration (D) of at least one of Nd and Pt. In this embodiment, Pr is diffused from each of the top surface 100T and the bottom surface 100B of the sintered R-T-B based magnet 100 into the interior thereof. As a result, as shown in FIG. 2B, a portion in which the Pr concentration gradually decreases from the surface toward the interior of the magnet is present on both of the top surface 100T side and the bottom surface 100B side as seen from the center of the magnet.

The significance of the sintered R-T-B based magnet 100 including a portion in which at least one of the Nd concentration and the Pr concentration gradually decreases from the surface toward the interior thereof will be described. As described above, the state where the sintered R-T-B based magnet 100 includes a portion in which at least one of the Nd concentration and the Pr concentration gradually decreases from the surface toward the interior thereof indicates that at least one of Nd and Pr is in a state of being diffused from the surface into the interior of the magnet. This state may be confirmed by, for example, a line analysis performed by use of Energy Dispersive X-ray Spectroscopy (EDX) on a region, of any cross-section of the sintered R-T-B based magnet 100, from the surface to the vicinity of the center thereof.

The Nd and Pr concentrations may vary in accordance with whether the site of measurement is in the main phase crystal grains (R₂T₁₄B compound grains) or at the grain boundaries, in the case where the site of measurement has a size of, for example, submicron order. In the case where the site of measurement is at the grain boundaries, the Nd or Pr concentration may vary locally or microscopically in accordance with the type or the manner of distribution of an Nd or Pr-containing compound that may be formed at the grain boundaries. However, in the case where Nd or Pr is diffused from the surface into the interior of the magnet, it is unequivocal that an average value of the concentrations of such an element at positions at an equal depth from the surface of the magnet gradually decreases from the surface toward the interior of the magnet. According to the present disclosure, in the case where at least one of the average concentration values of Nd and Pr, each measured with the depth being the function, decreases along with an increase in the depth in at least a region from the surface to a depth of 200 μm of the sintered R-T-B based magnet, it is defined that the sintered R-T-B based magnet includes a portion in which at least one of the Nd concentration and the Pr concentration gradually decreases.

During the production of the sintered R-T-B based magnet according to this embodiment, it is preferred that a metal element M (M is at least one selected from the group consisting of Ga, Cu, Zn, Al and Si), in addition to at least one of Nd and Pr, is diffused from the surface into the interior of the magnet. Therefore, in a more preferred embodiment, the sintered R-T-B based magnet includes a portion in which a concentration of element M (M is at least one selected from the group consisting of Ga, Cu, Zn, Al and Si) gradually decreases from the surface toward the interior thereof.

The state where the sintered R-T-B based magnet includes a portion in which the concentration of at least one of Nd and Pr and the concentration of M gradually decrease from the surface toward the interior thereof indicates that these elements are in a state of being diffused from the surface into the interior of the magnet. Whether or not the sintered R-T-B based magnet “includes a portion in which the concentration of a predetermined element gradually decreases from the surface toward the interior thereof” may be checked by, for example, a line analysis performed by use of Energy Dispersive X-ray Spectroscopy (EDX) on a region, of any cross-section of the sintered R-T-B based magnet, from the surface to the vicinity of the center thereof. There may be a case where the concentration of such a predetermined element is increased or decreased locally in accordance with whether the site of measurement is in the main phase crystal grains (R₂T₁₄B compound grains) or at the grain boundaries, or in accordance with the type or the presence/absence of a compound, containing R and the metal element M, that is generated in the pre-diffusion sintered R-T-B based body or at the time of diffusion. However, the overall concentration gradually decreases toward the interior of the magnet. Therefore, even if the concentration of a predetermined element is increased or decreased locally, the sintered R-T-B based magnet is deemed to be in the state of “including a portion in which the concentration of a predetermined element gradually decreases from the surface toward the interior thereof” as defined by the present disclosure.

The sintered R-T-B based magnet according to this embodiment may have, for example, the composition containing:
R: not lower than 26.8 mass % and not higher than 31.5 mass % (R is at least one of rare-earth elements, and contains Nd with no exception);
B: not lower than 0.85 mass % and not higher than 0.94 mass %;
M: not lower than 0.05 mass % and not higher than 2.0 mass % (M is at least one selected from the group consisting of Ga, Cu, Zn, Al and Si);
Q: not lower than 0 mass % and not higher than 2.0 mass % (Q is at least one selected from the group consisting of Ti, V, CR1-Mn, Ni, Zr, Nb, Mo, Ag, In, Sn, Hf, Ta, W, Pb and Bi); and
the remaining part T (T is Fe, or Fe and Co) and unavoidable impurities.

R may contain La, Ce, Pr, Pm, Sm, Eu or the like in addition to Nd. In general, O (oxygen), N (nitrogen), C (carbon) and the like are contained as unavoidable impurities. In an embodiment of the present disclosure, the behavior of O and C, in particular, is paid attention to, and a relationship between the contents thereof and a content of a predetermined rare-earth element is defined, so that high Bᵣ and high H_{cJ} are successfully provided. Preferably, where the content (mass %) of B is [B], 0.85 mass %≤[B]≤0.92 mass %. With such a range, higher H_{cJ} is provided.

Preferably, the sintered R-T-B based magnet contains M1 (M1 is at least one selected from the group consisting of Ga, Zn and Si). Where Ga is contained at a content (mass %) represented as [Ga], Zn is contained at a content (mass %) represented as [Zn], and Si is contained at a content (mass %) represented as [Si], the sintered R-T-B based magnet satisfies 0.35 mass %≤[M1]≤1.00 mass %. Expression (2) above and the above-mentioned specific range of B are satisfied, and M1 is contained at a content in the range that is not lower than 0.35 mass % and not higher than 1.00 mass %, so that higher H_{cJ} is provided.

Preferably, the sintered R-T-B based magnet contains Ga, and where the content (mass %) of Ga is [Ga], Ga is in the range of 0.40 mass %≤[Ga]≤0.80 mass %. Expression (2) above and the above-mentioned specific range of B are satisfied, and Ga is contained at a content in the range that is not lower than 0.40 mass % and not higher than 0.80 mass %, so that higher H_{cJ} is provided. More preferably, the sintered R-T-B based magnet contains Ga and Cu. Where the content (mass %) of Ga is [Ga] and the content (mass %) of Cu is [Cu], the sintered R-T-B based magnet satisfies [Ga]≥1.2×[Cu]. With such a range, higher H_{cJ} is provided.

According to an embodiment of the present disclosure, a sintered R-T-B based magnet having high Bᵣ and high H_{cJ} is provided while the amount of use of a heavy rare-earth element RH such as Tb or the like is decreased. Typically, when [Tb] represents the concentration of Tb (mass %), 0.05 mass %≤[Tb]≤0.20 mass %, and the remanence (Bᵣ) is not lower than 1.43 T and the coercivity (H_{cJ}) is not lower than 1900 kA/m. Preferably, Tb is not contained (except for unavoidable impurities), and the remanence (Bᵣ) is not lower than 1.40 T and the coercivity (H_{cJ}) is not lower than 1400 kA/m. Where Bᵣ has a value (T) of [Y] and H_{cJ} has a value (kA/m) of [X], the relationship of [Y]≥−0.0002×[X]+1.73 is satisfied. The state where the relationship of [Y]≥−0.0002×[X]+1.73 is satisfied indicates that high magnetic properties having a good balance between Bᵣ and H_{cJ} are provided.

### <Method for Producing the Sintered R-T-B Based Magnet>

Hereinafter, a method for producing the sintered R-T-B based magnet according to an embodiment of the present disclosure will be described.

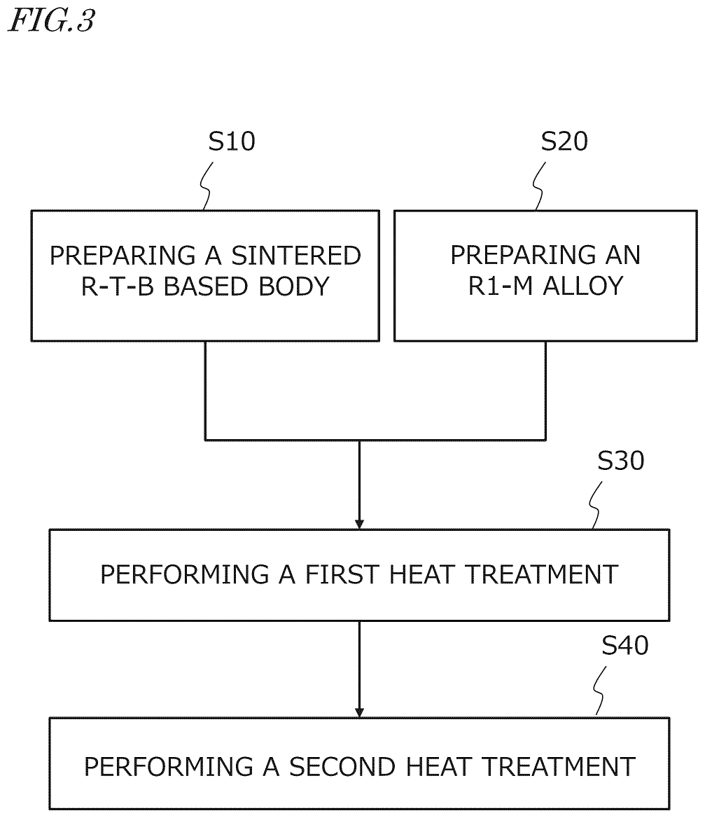

As shown in FIG. 3, the production method according to this embodiment may include step S10 of preparing a sintered R-T-B based body, step S20 of preparing an R1-M alloy, step S30 of performing a first heat treatment, and step S40 of performing a second heat treatment. In step S30, the sintered R-T-B based body and the R1-M alloy are subjected to a first heat treatment at a temperature not lower than 700° C. and not higher than 950° C. in a vacuum or an inert gas atmosphere, in a state where at least a portion of the R1-M alloy is kept in contact with at least a portion of the surface of the sintered R-T-B based body. As a result, R1 and M are diffused into the interior of the magnet. In step S40, the sintered R-T-B based magnet produced as a result of the first heat treatment is subjected to a second heat treatment at a temperature that is not lower than 450° C. and not higher than 750° C. but is lower than the temperature of the first heat treatment, in a vacuum or an inert gas atmosphere. Hereinafter, these steps will be described in more detail.

### (Step of Preparing the Sintered R-T-B Based Body)

First, a composition of the sintered R-T-B based body will be described.

One feature of the sintered R-T-B based body used in this embodiment is that the amounts of R, oxygen, carbon and the like contained therein are adjusted to produce a sintered R-T-B based magnet that satisfies expression (1) above. For this purpose, it is preferred to prepare a sintered R-T-B based body that satisfies the relationships of 0.85 mass %≤[B]≤0.94 mass %, 25.8 mass %≤([Nd]+[Pr]+[Ce]+[La]+[Dy]+[Tb]−12([O]+[C])≤27.5 mass %, and 0.05 mass %≤[O]≤0.30 mass %. It is preferred to prepare a sintered R-T-B based body that satisfies the relationship of 0.05 mass %≤[C]≤0.18 mass %. Such a sintered R-T-B based body is subjected to a diffusion step described below, so that R, M or the like is not excessively diffused into the interior of the sintered R-T-B based body and are significantly promoted to be diffused in the grain boundaries.

The sintered R-T-B based body to be prepared in this step has, for example, the following composition.
R: not lower than 26.6 mass % and not higher than 31.5 mass % (R is at least one of rare-earth elements, and contains Nd with no exception);
B: not lower than 0.85 mass % and not higher than 0.94 mass %;
M: not lower than 0 mass % and not higher than 1.5 mass % (M is at least one selected from the group consisting of Ga, Cu, Zn, Al and Si);
Q: not lower than 0 mass % and not higher than 2.0 mass % (Q is at least one selected from the group consisting of Ti, V, CR1-Mn, Ni, Zr, Nb, Mo, Ag, In, Sn, Hf, Ta, W, Pb and Bi); and
the remaining part T (T is Fe, or Fe and Co) and unavoidable impurities.

The sintered R-T-B based body also satisfies expression (1) above.

Now, a method for preparing the sintered R-T-B based body will be described.

First, an alloy for the sintered R-T-B based magnet is prepared, and is coarse-pulverized by, for example, a hydrogen pulverization method or the like.

A method for producing the alloy for the sintered R-T-B based magnet will be described. A metal material or an alloy adjusted in advance to have the above-described composition is melted, and the melted metal material or alloy is treated with an ingot casting method, specifically, put into a casting mold and solidified. As a result, an alloy ingot is produced. Alternatively, a strip casting method may be used, by which a metal material or an alloy adjusted in advance to have the above-described composition is melted, and the melted metal material or alloy is quenched by being in contact with a single roll, a twin roll, a rotary disc, a rotary cylindrical casting mold or the like to produce a quenched solidified alloy. Another quenching method such as a centrifugal casting method or the like may be used to produce a flake-like alloy.

According to an embodiment of the present disclosure, an alloy produced by either the ingot method or the quenching method is usable. It is preferred to use an alloy produced by the quenching method such as the strip casting method or the like. The alloy produced by the quenching method usually has a thickness in the range of 0.03 mm to 1 mm, and is flake-like. The melted alloy starts solidifying from a surface thereof that is in contact with a cooling roll (roll contact surface), and a crystal grows like a column in a thickness direction from the roll contact surface. The quenched alloy has been cooled in a shorter time period than an alloy (alloy ingot) produced by the conventional ingot casting method (mold casting method), and therefore, has a finer tissue, a shorter crystal grain size, and a larger area of grain boundaries. The R-rich phase largely expands in the grain boundaries. The quenching method is highly effective in dispersing the R-rich phase. For this reason, the R-rich phase is easily broken at the grain boundaries by a hydrogen pulverizing method. The quenched alloy may be hydrogen-pulverized, so that the hydrogen-pulverized powder (coarse-pulverized powder) has a size that is, for example, not longer than 1.0 mm. The coarse-pulverized powder formed in this manner is pulverized by, for example, a jet mill.

In this embodiment, conditions for the pulverization are adjusted such that the content of oxygen in the sintered R-T-B based magnet produced as a final product is in a specific range (0.05 mass %≤[O]≤0.30 mass %). The jet mill pulverization is performed in an atmosphere of inert gas such as nitrogen or the like. The pulverization may be performed by, for example, a jet mill in a humid atmosphere. Preferably, the powder particles are caused to have a small size (the mean particle size is not shorter than 2.0 μm and not longer than 10.0 μm; more preferably, is not shorter than 2.0 μm and not longer than 8.0 μm; still more preferably, is not shorter than 2.0 μm and not longer than 4.5 μm; and yet more preferably, is not shorter than 2.0 μm and not longer than 3.5 μm). The powder particles may be made small, so that high H_{cJ} is provided.

Fine-pulverized powder to be used to produce the sintered R-T-B based body may be formed of one type of raw material alloy (single raw-material alloy) or formed by a method of mixing two or more types of raw material alloys (by a blend method), as long as the above-described conditions are satisfied.

According to a preferred embodiment, a powder compact is formed of the above-mentioned fine-pulverized powder by a magnetic field press, and then is sintered. Preferably, the magnetic field press is performed in an inert gas atmosphere or by a wet press from the point of view of suppressing oxygen. In the case where, in particular, the wet press is used, surfaces of particles that form the powder compact are covered with a dispersant such as oil or the like and thus are suppressed from being in contact with oxygen or water vapor in the air. Therefore, the particles are prevented or suppressed from being oxidized by the air before, during, or after the pressing step. This makes it easy to control the content of oxygen to be within a predetermined range. In the case where the magnetic field wet press is performed, a slurry of the fine-pulverized powder mixed with a dispersion medium is prepared, and is supplied to a cavity of a mold of a wet press device to be pressed in a magnetic field. Alternatively, the sintered R-T-B based body may be prepared by a known method such as the PLP (Press-Less Process) described in, for example, Japanese Laid-Open Patent Publication No. 2006-19521, instead of such a press method being used.

Next, the compact is sintered to produce the sintered R-T-B based body. Preferably, the compact is sintered at a temperature in the range of 950° C. to 1150° C. In order to prevent the compact from being oxidized by sintering, the remaining gas in the atmosphere may be replaced with inert gas such as helium, argon or the like. The obtained sintered body may be heat-treated. The conditions of heat treatment such as the heat treatment temperature, the heat treatment time and the like may be known conditions.

### (Step of Preparing the R1-M Alloy)

In this embodiment, an alloy containing R1, or R1 and M, is diffused from the surface into the interior of the sintered R-T-B based body. For performing this, an R1-M alloy containing the element(s) to be diffused is prepared.

First, a composition of the R1-M alloy will be described. In the R1-M alloy, R1 is at least one of rare-earth elements. Preferably, with respect to the entirety of the R1-M alloy, R1 is contained at a content that is not lower than 65 mass % and not higher than 100 mass %. M is at least one selected from the group consisting of Ga, Cu, Zn, Al and Si, and is preferably contained at a content that is not lower than 0 mass % and not higher than 35 mass % with respect to the entirety of the R1-M alloy. Preferably, R1 contains at least one of Nd and Pr. More preferably, R1 contains Pr with no exception. It is preferred that the content of Pr, contained in R1, is not lower than 65 mass % and not higher than 86 mass % with respect to the entirety of the R1-M alloy. Preferably, the content of Pr in the R1-M alloy is not lower than 50 mass % with respect to the entirety of R1. More preferably, the content of Pr in the R1-M alloy is not lower than 65 mass % with respect to the entirety of R1. In the case where R1 contains Pr, the diffusion in the grain boundary phase progresses easily, which allows the diffusion in the grain boundaries to be promoted. As a result, higher H_{cJ} is provided.

The R1-M alloy may have any shape or size with no specific limitation. The R1-M alloy may be in the form of film, foil, powder, blocks, particles or the like.

Now, a method for preparing the R1-M alloy will be described.

The R1-M alloy may be prepared by a method for producing a raw material alloy that is adopted in generic methods for producing a sintered R-T-B based magnet, for example, a mold casting method, a strip casting method, a single roll rapid quenching method (melt spinning method), an atomization method, or the like. Alternatively, the R1-M alloy may be prepared by pulverizing an alloy obtained as above with a known pulverization device such as a pin mill or the like.

### (Diffusion Step)

A diffusion step is performed, by which the sintered R-T-B based body and the R1-M alloy prepared by the above-described methods are subjected to the first heat treatment at a temperature not lower than 700° C. and not higher than 950° C. in a vacuum or an inert gas atmosphere, in a state where at least a portion of the R1-M alloy is kept in contact with at least a portion of the surface of the sintered R-T-B based body, to diffuse R1 and M into the interior of the magnet. As a result, a liquid phase containing R1 and M is generated from the R1-M alloy, and the liquid phase is introduced from the surface into the interior of the sintered body through diffusion, via the grain boundaries in the sintered R-T-B based body.

In the case where the temperature of the first heat treatment is lower than 700° C., the amount of the liquid phase containing, for example, R1 and M is too small to provide high H_{cJ}. By contrast, in the case where the temperature of the first heat treatment is higher than 950° C., the H_{cJ} may possibly be decreased. Preferably, the temperature of the first heat treatment is not lower than 850° C. and not higher than 950° C. With such a temperature range, higher H_{cJ} is provided. It is preferred that the sintered R-T-B based magnet produced as a result of the first heat treatment (not lower than 700° C. and not higher than 950° C.) is cooled down to 300° C. at a cooling rate of at least 5° C./minute from the temperature of the first heat treatment. With such cooling, higher H_{cJ} is provided. More preferably, the cooling rate down to 300° C. is at least 15° C./minute.

The first heat treatment may be performed by use of a known heat treatment apparatus on the R1-M alloy of any shape located on the surface of the sintered R-T-B based body. For example, the first heat treatment may be performed in a state where the surface of the sintered R-T-B based body is covered with a powder layer of the R1-M alloy. For example, a slurry having the R1-M alloy dispersed in a dispersion medium may be applied onto the surface of the sintered R-T-B based body, and then the dispersion medium may be evaporated to allow the R1-M alloy to come into contact with the sintered R-T-B based body. Examples of the dispersion medium include alcohols (ethanol, etc.), aldehydes, and ketones. Alternatively, the first treatment may be performed in a state where, for example, a film of the R1-M alloy is formed on the surface of the sintered R-T-B based body by use of a known sputtering device. The heavy rare-earth element RH is not limited to being introduced from the R1-M alloy, but may also be introduced from a fluoride, an oxide, an oxyfluoride or the like of the heavy rare-earth element RH located, together with the R1-M alloy, on the surface of the sintered R-T-B based magnet. Examples of the fluoride, oxide, and oxyfluoride of the heavy rare-earth element RH include TbF₃, DyF₃, Tb₂O₃, Dy₂O₃, TbOF, and DyOF.

The R1-M alloy may be located at any position as long as at least a portion thereof is in contact with at least a portion of the sintered R-T-B based body.

### (Step of Performing the Second Heat Treatment)

The sintered R-T-B based magnet produced as a result of the first heat treatment is subjected to a heat treatment at a temperature that is not lower than 400° C. and not higher than 750° C. but is lower than the temperature used in the step of performing the first heat treatment, in a vacuum or an inert gas atmosphere. In the present disclosure, this heat treatment is referred to as the “second heat treatment”. The second heat treatment allows high H_{cJ} to be provided. In the case where the second heat treatment is performed at a temperature higher than that of the first heat treatment, or in the case where the temperature of the second heat treatment is lower than 400° C. or higher than 750° C., high H_{cJ} may not possibly be provided.

### EXAMPLES

### Experiment Example 1

Raw materials of the elements were weighed such that the sintered R-T-B based body would have a composition of each of No. A through No. P in Table 1, and alloys were produced by a strip casting method. Each of the obtained alloys was coarse-pulverized by a hydrogen pulverization method to obtain coarse-pulverized powder. Next, zinc stearate as a lubricant was incorporated into, and mixed with, the obtained coarse-pulverized powder, and then the resultant substance was dry-milled in a nitrogen jet by an airflow crusher (jet mill machine) to obtain fine-pulverized powder (alloy powder) having a grain₅₀ of about 3 μm. Zinc stearate as a lubricant was incorporated into, and mixed with, the obtained fine-pulverized powder, and then the resultant substance was pressed in a magnetic field to obtain a compact. As a pressing apparatus, a so-called orthogonal magnetic field pressing apparatus (transverse magnetic field pressing apparatus) was used, in which the direction of magnetic field application was orthogonal to the pressurizing direction. The obtained compact was kept at a temperature not lower than 1000° C. and not higher than 1090° C. (a temperature at which a sufficiently dense texture would result through sintering was selected for each sample) for 4 hours in a vacuum to be sintered. As a result, a sintered R-T-B based body was obtained. The sintered R-T-B based bodies thus obtained each had a density not lower than 7.5 Mg/m³. The components of the obtained sintered R-T-B based bodies are shown in Table 1. The contents of the components shown in Table 1 were measured by use of Inductively Coupled Plasma Optical Emission Spectroscopy (ICP-OES).

TABLE 1

| | COMPOSITION OF SINTERED R-T-B BASED BODY | | | | | | | | | | |
|---|---|---|---|---|---|---|---|---|---|---|---|
| | (mass %) | | | | | | | | | | |
| No | Nd | Pr | Dy | Tb | B | Co | Al | Cu | Ga | Zr | Fe |
| A | 22.7 | 5.4 | 0.00 | 0.00 | 0.88 | 0.11 | 0.05 | 0.04 | 0.01 | 0.11 | bal. |
| B | 22.8 | 5.4 | 0.00 | 0.00 | 0.88 | 0.11 | 0.05 | 0.04 | 0.11 | 0.11 | bal. |
| C | 22.8 | 5.4 | 0.00 | 0.00 | 0.88 | 0.11 | 0.05 | 0.04 | 0.52 | 0.11 | bal. |
| D | 22.8 | 5.4 | 0.00 | 0.00 | 0.90 | 0.11 | 0.05 | 0.04 | 0.01 | 0.11 | bal. |
| E | 22.9 | 5.4 | 0.00 | 0.00 | 0.90 | 0.11 | 0.05 | 0.04 | 0.11 | 0.11 | bal. |
| F | 22.8 | 5.4 | 0.00 | 0.00 | 0.90 | 0.11 | 0.05 | 0.04 | 0.52 | 0.11 | bal. |
| H | 22.8 | 5.4 | 0.00 | 0.00 | 0.92 | 0.11 | 0.05 | 0.04 | 0.11 | 0.11 | bal. |
| I | 22.8 | 5.4 | 0.00 | 0.00 | 0.92 | 0.11 | 0.04 | 0.04 | 0.52 | 0.11 | bal. |
| N | 22.9 | 5.4 | 0.00 | 0.00 | 0.97 | 0.11 | 0.05 | 0.04 | 0.11 | 0.11 | bal. |
| O | 22.9 | 5.4 | 0.00 | 0.00 | 0.97 | 0.11 | 0.04 | 0.04 | 0.52 | 0.11 | bal. |
| P | 22.6 | 5.4 | 0.29 | 0.00 | 0.9 | 0.10 | 0.05 | 0.05 | 0.10 | 0.10 | bal. |

The raw materials of the elements were weighed such that the R1-M alloy would generally have a composition of each of No. a and No. b in Table 2, and were melted and treated with a single roll rapid quenching method (melt spinning method) to obtain a ribbon-like or flake-like alloy. The obtained alloys were each pulverized in an argon atmosphere by use of a mortar, and caused to pass through a sieve having 425 μm openings. As a result, the R1-M alloys were prepared. The compositions of the R1-M alloys thus obtained are shown in Table 2.

TABLE 2

COMPOSITION OF R1-M ALLOY
(mass %)

| No | Pr | Tb | Cu | Ga |
|---|---|---|---|---|
| a | 90 | 0 | 7 | 3 |
| b | 77 | 13 | 5 | 5 |

The sintered R-T-B based bodies of No. A through No. P in Table 1 were each cut and ground into a cube having a size of 7.4 mm×7.4 mm×7.4 mm. Next, the R1-M alloy (each of No. a and No. b) was sprayed at a content in the range of 1.7 to 4.2 mass % on the entirety of each of 100 mass % of the sintered R-T-B based bodies of No. A through No. P. Table 3 shows that the sintered R-T-B based magnet of No. 1 was obtained as a result of the diffusion step performed on the sintered R-T-B based body of No. B in Table 1 and the R1-M alloy of No. a in Table 2. In substantially the same manner, Table 3 shows the sintered R-T-B based body and the R1-M alloy used to form the sintered R-T-B based magnet of each of No. 2 through No. 16. The diffusion step was performed as follows. The sintered R-T-B based body and the R1-M alloy of each combination were subjected to the first heat treatment at 900° C. for 4 hours in low-pressure argon gas controlled to be 50 Pa, and then cooled down to room temperature. As a result, a post-first heat treatment sintered R-T-B based magnet was obtained. Then, the post-first heat treatment sintered R-T-B based magnet was subjected to the second heat treatment at 480° C. for 3 hours in low-pressure argon gas controlled to be 50 Pa, and then cooled down to room temperature. As a result, a sintered R-T-B based magnet (each of No. 1 through No, 16) was produced. Table 3 shows the compositions of the obtained sintered R-T-B based magnets. Shown in the data fields of expression (2) in Table 3 are the values of ([Nd]+[Pr]+[Ce]+[La]+[Dy]+[Tb])−12 ([O]+[C]). The content of O (oxygen) was measured by a gas fusion-infrared absorption method by use of a gas analyzer. It was checked whether or not the atomic ratio of B with respect to T in each sintered R-T-B based magnet was lower than the atomic ratio of B with respect to T in the stoichiometric composition of the R₂T₁₄B compound. Table 3 shows the results in the data fields of expression (1). “◯” indicates that expression (1), that is, the relationship of [T]/55.85>14×[B]/10.8 is satisfied. “×” indicates that the relationship is not satisfied. The obtained sintered R-T-B based magnet samples were each mechanically processed to have a size of 7 mm×7 mm×7 mm, and magnetic properties thereof were measured by a B-H tracer. The measurement results are shown in Table 3. A region, of a cross-section of the magnet of each of No. 1 through No. 16, from the surface to the vicinity of the center thereof was subjected to a line analysis performed by use of EDX. As a result, it has been found out regarding No. 14 that the Tb, Pr, Ga and Cu concentrations gradually decrease from the surface toward the interior thereof. It has been found out regarding the other magnets (No. 1 through No. 13, No. 15 and No. 16) that the Pr, Ga and Cu concentrations gradually decrease from the surface toward the interior thereof.

TABLE 3

| | COMPOSITION OF SINTERED R-T-B BASED MAGNET (mass %) | | | | | | | | | |
|---|---|---|---|---|---|---|---|---|---|---|
| | EXPRESSION | | | | | | | | | EXPRESSION |
| No. | (2) | B | Cu | Ga | Al | M | Tb | O | C | (1) |
| 1 | 26.3 | 0.87 | 0.08 | 0.22 | 0.05 | 0.35 | 0.00 | 0.10 | 0.12 | ◯ |
| 2 | 26.7 | 0.87 | 0.11 | 0.28 | 0.05 | 0.44 | 0.00 | 0.10 | 0.12 | ◯ |
| 3 | 27.0 | 0.87 | 0.11 | 0.66 | 0.05 | 0.82 | 0.00 | 0.09 | 0.12 | ◯ |
| 4 | 27.1 | 0.88 | 0.12 | 0.29 | 0.05 | 0.46 | 0.00 | 0.10 | 0.12 | ◯ |
| 5 | 27.2 | 0.88 | 0.12 | 0.68 | 0.05 | 0.85 | 0.00 | 0.09 | 0.12 | ◯ |
| 6 | 27.4 | 0.86 | 0.14 | 0.26 | 0.05 | 0.45 | 0.00 | 0.10 | 0.12 | ◯ |
| 7 | 27.2 | 0.86 | 0.13 | 0.33 | 0.05 | 0.51 | 0.00 | 0.10 | 0.12 | ◯ |
| 8 | 27.4 | 0.87 | 0.13 | 0.69 | 0.05 | 0.87 | 0.00 | 0.09 | 0.12 | ◯ |
| 9 | 27.5 | 0.88 | 0.14 | 0.26 | 0.05 | 0.45 | 0.00 | 0.10 | 0.12 | ◯ |
| 10 | 27.5 | 0.88 | 0.14 | 0.35 | 0.05 | 0.54 | 0.00 | 0.10 | 0.12 | ◯ |
| 11 | 27.6 | 0.88 | 0.14 | 0.72 | 0.05 | 0.91 | 0.00 | 0.09 | 0.12 | ◯ |
| 12 | 27.4 | 0.90 | 0.14 | 0.34 | 0.05 | 0.53 | 0.00 | 0.10 | 0.11 | ◯ |
| 13 | 27.0 | 0.91 | 0.12 | 0.67 | 0.04 | 0.83 | 0.00 | 0.10 | 0.12 | ◯ |
| 14 | 26.6 | 0.90 | 0.18 | 0.24 | 0.05 | 0.47 | 0.19 | 0.14 | 0.11 | ◯ |
| 15 | 26.5 | 0.95 | 0.09 | 0.25 | 0.05 | 0.39 | 0.00 | 0.11 | 0.12 | ◯ |
| 16 | 26.4 | 0.95 | 0.08 | 0.58 | 0.04 | 0.70 | 0.00 | 0.10 | 0.12 | ◯ |

| | MAGNETIC | | CONDITIONS FOR | | |
|---|---|---|---|---|---|
| | PROPERTIES | | DIFFUSION | | |
| | Br | HcJ | SINTERED R-T-B | R1-M | |
| No. | (T) | (k A/m) | BASED BODY | ALLOY | REMARKS |
| 1 | 1.47 | 1524 | B | a | PRESENT INVENTION |
| 2 | 1.44 | 1697 | B | a | PRESENT INVENTION |
| 3 | 1.43 | 1713 | C | a | PRESENT INVENTION |
| 4 | 1.44 | 1649 | E | a | PRESENT INVENTION |
| 5 | 1.44 | 1537 | F | a | PRESENT INVENTION |
| 6 | 1.43 | 1767 | A | a | PRESENT INVENTION |
| 7 | 1.43 | 1792 | B | a | PRESENT INVENTION |
| 8 | 1.42 | 1796 | C | a | PRESENT INVENTION |
| 9 | 1.43 | 1708 | D | a | PRESENT INVENTION |
| 10 | 1.43 | 1745 | E | a | PRESENT INVENTION |
| 11 | 1.43 | 1681 | F | a | PRESENT INVENTION |
| 12 | 1.44 | 1528 | H | a | PRESENT INVENTION |
| 13 | 1.45 | 1404 | I | a | PRESENT INVENTION |
| 14 | 1.43 | 2120 | P | b | PRESENT INVENTION |
| 15 | 1.47 | 1279 | N | a | COMPARATIVE EXAMPLE |
| 16 | 1.47 | 1298 | O | a | COMPARATIVE EXAMPLE |

As shown in Table 3, each of No. 1 through No. 13, which are examples of the present invention, does not contain Tb, and has remanence Bᵣ not lower than 1.40 T and coercivity H_{cJ} not lower than 1400 kA/m. Where the value (T) of Bᵣ is [Y] and the value (kA/m) of H_{cJ} is [X], each of No. 1 through No. 13 satisfies the relationship of [Y]≥−0.0002×[X]+1.73. A sintered R-T-B based magnet having high Bᵣ and high H_{cJ} is provided while the amount of use of a heavy rare-earth element RH such as Tb or the like is decreased. By contrast, none of the comparative examples (No. 15 and No. 16) outside of the ranges of the present disclosure has high remanence (Bᵣ) of at least 1.40 T or high coercivity (H_{cJ}) of at least 1400 kA/m. No. 14, which is an example of the present invention, contains Tb in the range of 0.05≤[Tb]≤0.20 mass %, and has remanence (Bᵣ) not lower than 1.43 T and coercivity (H_{cJ}) not lower than 1900 kA/m. A sintered R-T-B based magnet having high Bᵣ and high H_{cJ} is provided while the amount of use of a heavy rare-earth element RH such as Tb or the like is decreased.

### REFERENCE SIGNS LIST

10: main phase formed of an R₂T₁₄B compound; 14: grain boundary phase; 14a: intergranular grain boundary phase; 14b: grain boundary triple junction

1: A sintered R-T-B based magnet (where R is at least one of rare-earth elements and contains with no exception, T is Fe or Fe and Co, and B is boron), comprising:
a main phase formed of an R₂T₁₄B compound; and
a grain boundary phase that is at grain boundaries of the main phase,
wherein where:
Nd is contained at a content (mass %) represented as [Nd],
Pr is contained at a content (mass %) represented as [Pr],
Ce is contained at a content (mass %) represented as [Ce],
La is contained at a content (mass %) represented as [La],
Dy is contained at a content (mass %) represented as [Dy],
Tb is contained at a content (mass %) represented as [Tb],
B is contained at a content (mass %) represented as [B],
O is contained at a content (mass %) represented as [O],
C is contained at a content (mass %) represented as [C], and
M (M is at least one selected from the group consisting of Ga, Cu, Zn, Al and Si) is contained at a content (mass %) represented as [M],
an atomic ratio of B with respect to T in the sintered R-T-B based magnet is lower than an atomic ratio of B with respect to T in a stoichiometric composition of the R₂T₁₄B compound,
the sintered R-T-B based magnet satisfies the relationships of:
$$26. mass \% \leq ( [ Nd ] + [ Pr ] + [ Ce ] + [ La ] + [ Dy ] + [ Tb ] ) - 12 ( [ O ] + [ C ] ) \leq 27.7 mass \% ,$$
$$0.85 mass \% \leq [ B ] \leq 0.94 mass \% ,$$
$$0.05 mass \% \leq [ O ] \leq 0.3 mass \% ,$$
$$0.05 mass \% \leq [ M ] \leq 2. mass \% ,$$
$$\underline{0.05 mass \% \leq [ C ] \leq 0.18 mass \% ,}$$
$$[ Tb ] \leq 0.2 mass \% , and$$
$$[ Dy ] \leq 0.3 mass \% ,$$
the grain boundary phase includes a rare-earth oxide, and
the sintered R-T-B based magnet includes a portion in which at least one of a concentration of Nd and a concentration of Pr gradually decreases from a surface toward an interior thereof.

2: The sintered R-T-B based magnet of claim 1, comprising a portion in which a concentration of M gradually decreases from the surface toward the interior thereof.

3: The sintered R-T-B based magnet of claim 1, comprising a portion in which a concentration of Pr gradually decreases from the surface toward the interior thereof.

4: The sintered R-T-B based magnet of claim 1, wherein 0.85 mass %≤[B]≤0.92 mass %.

5: The sintered R-T-B based magnet of claim 1, wherein 0.05 mass %≤[Tb]≤0.20 mass %, and the sintered R-T-B based magnet has remanence Bᵣ not lower than 1.43 T and coercivity H_{cJ} not lower than 1900 kA/m.

6: The sintered R-T-B based magnet of claim 1, wherein:
the sintered R-T-B based magnet does not contain Tb (except for unavoidable impurities) and has remanence Bᵣ not lower than 1.40 T and coercivity H_{cJ} not lower than 1400 kA/m, and
where Bᵣ has a value (T) of [Y] and H_{cJ} has a value (kA/m) of [X], the sintered R-T-B based magnet satisfies the relationship of [Y]≥−0.0002×[X]+1.73.

7: The sintered R-T-B based magnet of claim 1, further comprising Ga and Cu, wherein where Ga is contained at a content (mass %) represented as [Ga] and Cu is contained at a content (mass %) represented as [Cu], [Ga]≥1.2×[Cu].

8: The sintered R-T-B based magnet of claim 1, wherein:
the sintered R-T-B based magnet contains Ga, and
0.40 mass %≤[Ga], where the content of Ga (mass %) is represented as [Ga].

9: The sintered R-T-B based magnet of claim 8, wherein [Ga]≤0.80 mass %.

10: The sintered R-T-B based magnet of claim 1, wherein 0.11 mass %≤[C].
